(19) United States
(12) Patent Application Publication
(10) Pub. No.: US 2026/0342765 A1
(43) Pub. Date: Oct. 29, 2026

(54) METHODS AND SYSTEMS FOR FACILITATING MANAGEMENT OF DISTRIBUTION ASSOCIATED WITH A PLURALITY OF MESSAGES

(71) Applicant: Business research and development company T2, Riyadh (SA)

(72) Inventor: Abdullah Aldosari, Riyadh (SA)

(21) Appl. No.: 19/193,728

(22) Filed: Apr. 29, 2025

(51) Int. Cl. H04L 51/226; H04W 4/14

(52) U.S. Cl. CPC H04L 51/226; H04W 4/14

(57) ABSTRACT

The present disclosure provides a method for facilitating management of distribution Further, the method may include receiving a message data from a client device associated with a client. Further, the message data includes two or more message data. Further, the each of the two or more message data represents a message. Further, the method may include analyzing the each of the two or more message data. Further, the method may include generating a priority level data based on the analyzing. Further, the priority level data corresponds associated with each of the two or more messages. Further, the method may include allocating a session resource to each of the two or more messages based on the priority level data. Further, the session resource corresponds facilitating the distribution of the two or more messages. Further, the transmitting may be based on a SMPP protocol.

### FIELD OF DISCLOSURE

The present invention relates to the field of data processing. More specifically, the present disclosure relates to methods and systems for facilitating management of distribution associated with a plurality of messages.

### BACKGROUND

The field of Short Message Service (SMS) technology plays a pivotal role in modern communication systems. SMS messages have become a cornerstone of real-time information dissemination, serving as critical alerts, notifications, and interactive content delivery across industries such as healthcare, public safety, banking, and retail. The ability to send and receive text messages instantaneously has revolutionized how organizations communicate with their stakeholders, enabling swift responses and decision-making.

The ever-increasing reliance on SMS technology highlights the need for efficient and reliable message delivery systems. However, as the volume of SMS traffic continues to grow, so do the challenges associated with managing this data effectively. Ensuring that high-priority messages such as urgent alerts or critical notifications are delivered promptly while maintaining the overall efficiency of the system remains a significant challenge in the field. One of the primary objectives of the SMS communication systems is to enhance the speed and reliability of message delivery. This objective is particularly important for industries where delays can have substantial real-world consequences, such as in public safety, healthcare, and financial services. Achieving this objective requires not only the ability to handle large volumes of messages but also the capacity to prioritize them effectively based on their importance.

The problems associated with existing SMS systems are multifaceted. First, traditional systems often struggle to manage message prioritization, leading to situations where high-priority messages are delayed by lower-priority ones. This inefficiency can result in critical delays, particularly during peak traffic periods or network congestion. Additionally, existing systems may lack the ability to dynamically adjust their operations based on real-time data, such as network conditions or user behavior, which can lead to suboptimal resource utilization.

Another significant issue is the limited scalability of many SMS systems. As the demand for SMS services grows, systems must be able to adapt to increased loads without compromising performance. However, many existing solutions are ill-equipped to handle this scalability, often resulting in bottlenecks and overburdened infrastructure. Finally, there is a lack of integration between SMS systems and advanced technologies such as machine learning and geolocation-based optimization. These innovations have the potential to enhance the efficiency and reliability of SMS delivery but are not widely implemented in current systems.

Another critical challenge associated with existing SMS systems lies in addressing scaling limitations faced by SMS service providers, particularly those operating within the telecommunications sector. These challenges arise due to channel capacity constraints and the inability to implement a sophisticated prioritization mechanism that fully leverages SMPP session capabilities for efficient resource allocation based on priority levels.

Therefore, there is a need for improved methods and systems for facilitating management of distribution associated with a plurality of messages.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for facilitating management of distribution associated with two or more messages. Further, the method may include receiving, using a communication device, a message data from a client device associated with a client. Further, the message data includes two or more message data. Further, the each of the two or more message data represents a message. Further, the method may include analyzing, using a processing device, the each of the two or more message data. Further, the method may include generating, using the processing device, a priority level data based on the analyzing. Further, the priority level data corresponds to a priority level associated with each of the two or more messages. Further, the method may include allocating, using the processing device, a session resource to each of the two or more messages based on the priority level data. Further, the session resource corresponds to a resource associated with a session facilitating the distribution of the two or more messages. Further, the method may include transmitting, using the communication device, one or more of the two or more message data to a user device based on the allocating. Further, the transmitting may be based on a SMPP protocol.

The present disclosure provides a system for facilitating management of distribution associated with two or more messages. Further, the system may include a communication device. Further, the communication device may be configured for receiving a message data from a client device associated with a client. Further, the message data includes two or more message data. Further, the each of the two or more message data represents a message. Further, the communication device may be configured for transmitting one or more of the two or more message data to a user device based on an allocating. Further, the transmitting may be based on a SMPP protocol. Further, the system may include a processing device. Further, the processing device may be configured for analyzing the each of the two or more message data. Further, the processing device may be configured for generating a priority level data based on the analyzing. Further, the priority level data corresponds to a priority level associated with each of the two or more messages. Further, the processing device may be configured for allocating a session resource to each of the two or more messages based on the priority level data. Further, the session resource corresponds to a resource associated with a session facilitating the distribution of the two or more messages.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating management of distribution associated with a plurality of messages, in accordance with some embodiments.

FIG. 4 illustrates a flowchart of a method 400 for facilitating management of distribution associated with a plurality of messages including evaluating, using the processing device 504, the threshold value data associated with each of the plurality of queues, in accordance with some embodiments.

FIG. 5 illustrates a block diagram of a system 500 for facilitating management of distribution associated with a plurality of messages, in accordance with some embodiments.

FIG. 6 illustrates a user interface associated with methods and systems for facilitating management of distribution associated with a plurality of messages, in accordance with some embodiments.

FIG. 7 illustrates a flowchart of priority distribution speed associated with methods and systems for facilitating management of distribution associated with a plurality of messages, in accordance with some embodiments.

FIG. 8 illustrates a flowchart priority distribution speed associated with methods and systems for facilitating management of distribution associated with a plurality of messages, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure, introduces a system designed to manage and prioritize message distribution across multiple Short Message Peer-to-Peer (SMPP) connections. This system ensures that high-priority messages are processed first, thereby optimizing resource allocation and maintaining system performance.

In some embodiments, the present disclosure comprises:
RiCH Sending Engine (RSE) consisting of multiple SMPP connections, connected to SMS providers.
Each SMPP connection in RSE consists of multiple SMPP sessions.
The overall connection speed is the total of the submission rates across all sessions.
Each session is configured to handle and submit a limited number of SMS messages per second (SendSpeedLimit).
For instance, if the connection includes 10 sessions, and each session is configured to submit 10 messages per second, the total connection speed will be approximately 100 messages per second.

In some embodiments, the present disclosure describes the following functionality associated with the priority distribution speed algorithm:
The speed limit for the RSE connection, designed to prioritize high-priority messages first.
If the configured speed limit for the RSE connection is set to 10 messages per session, the SMPP session is structured to send high-priority messages first, followed by normal messages, low priority messages, and then very low-priority messages.
In this distribution mechanism, the connection memory holds four queues for high, normal, low, and very low-priority messages.
Each session will dequeue messages in a way that serves all priorities, ensuring that higher-priority messages are processed first.
For each priority, there is a defined sending rate per second.
Additionally, each SMPP connection is associated with a threshold setting that allows for efficient utilization of session capacity based on priority, particularly where insufficient high-priority messages are present in the traffic.

In some embodiments, the present disclosure describes the following advantages:
Utilizing session's capacity with highest priority messages.
Handling more capacity of messages over SMPP session's speed with respecting priorities.
If there no high priority messages, session speed will be utilized with lower priority messages.
Having more distribution for priorities over sessions within speed limit, which allow more traffic handling.

In some embodiments, the present disclosure describes a system enabling the distribution of incoming SMS messages from clients across multiple SMS connections provided by one or more telecom providers. The system prioritizes SMS messages according to established criteria, which may be specified in the metadata associated with each message or inferred from the content thereof. To manage these priorities efficiently, the gateway maintains separate queues for each priority level. The allocation of SMS connection resources is governed by threshold values assigned to each queue, allowing the system to first fully serve higher-priority messages before transitioning to lower-priority queues once the incoming rate of higher-priority messages falls below a specified threshold.

In some embodiments, the present disclosure describes a system prioritizing SMS messages based on their urgency, employing a hierarchical approach to manage resources efficiently. Initially, high-priority messages receive full allocation of available resources. If the incoming rate of these messages falls below a specified threshold (referred to as delta), the gateway allocates additional resources to the next priority level. This process continues until the second tier's message rate drops below its respective threshold (gamma), at which point resources are reallocated to serve the third level, up to gamma. Through this method, the system ensures optimal utilization of SMS connections by addressing lower-priority messages only when higher priorities no longer require full allocation.

In some embodiments, the present disclosure describes a system employing real-time adaptive processing algorithms to dynamically adjust submission rates based on network congestion and message priority. This ensures that high-priority messages are immediately attended to without causing delays or overburdening the system during peak times.

In some embodiments, the present disclosure may include intelligent queuing mechanisms that automatically categorize messages into priority queues, ensuring each category is processed in the correct order. This feature prevents lower-priority messages from delaying higher ones, enhancing overall efficiency and reliability. Further, in some embodiments, the present disclosure may dynamically optimize resource allocation by prioritizing message processing based on real-time data analysis. This maximizes SMS sending capacity without compromising performance, ensuring efficient resource utilization.

In some embodiments, the present disclosure describes the algorithm integrating seamlessly with multiple SMPP connections, allowing messages to be sent via the most efficient provider based on priority and current network conditions. This scalability accommodates varying demands and service quality, ensuring optimal message delivery. Further, each session adheres to defined message-per-second limits, preventing system overload while maintaining priority-based processing. This ensures reliable and scalable message delivery, complying with traffic limits and enhancing overall performance.

In some embodiments, the present disclosure describes utilization of adaptive tuning techniques to adjust priorities based on usage patterns observed over time. This allows the system to respond dynamically to changing demands, improving efficiency and effectiveness in managing SMS priorities.

In some embodiments, the present disclosure may incorporate machine learning models to dynamically assess message importance based on contextual factors such as sender reputation, content type, and recipient behavior. This advanced feature enhances prioritization accuracy and adaptability.

In some embodiments, the present disclosure may include optional encryption features that automatically encrypt high-priority or sensitive messages, ensuring secure delivery while maintaining priority processing. This adds an extra layer of protection for critical communications. Further, real-time network analytics tools may be integrated to provide insights into message delivery performance, allowing the system to make data-driven decisions on prioritization and routing adjustments. This enhances overall efficiency and reliability.

In some embodiments, the present disclosure describes an algorithm implementing load balancing strategies that effectively distribute messages across multiple service providers based on their current operational capacities and performance metrics. This method ensures efficient routing, thereby achieving reduced delivery times and enhancing overall system performance.

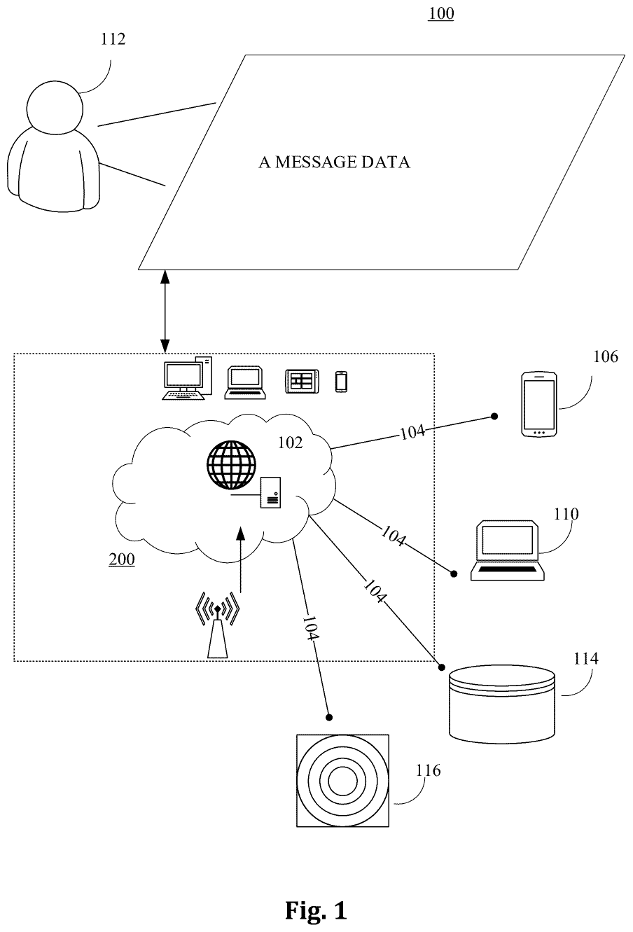

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

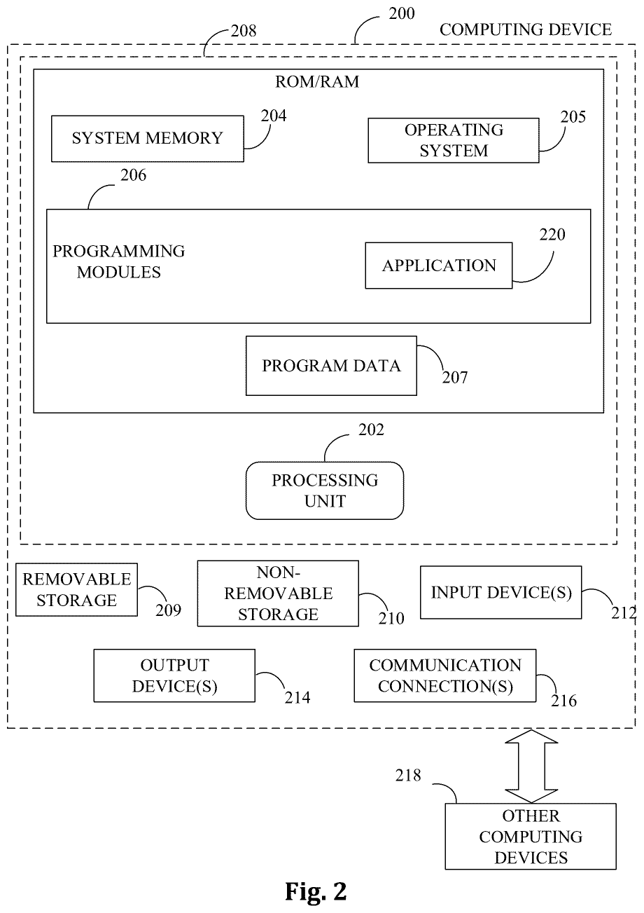

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

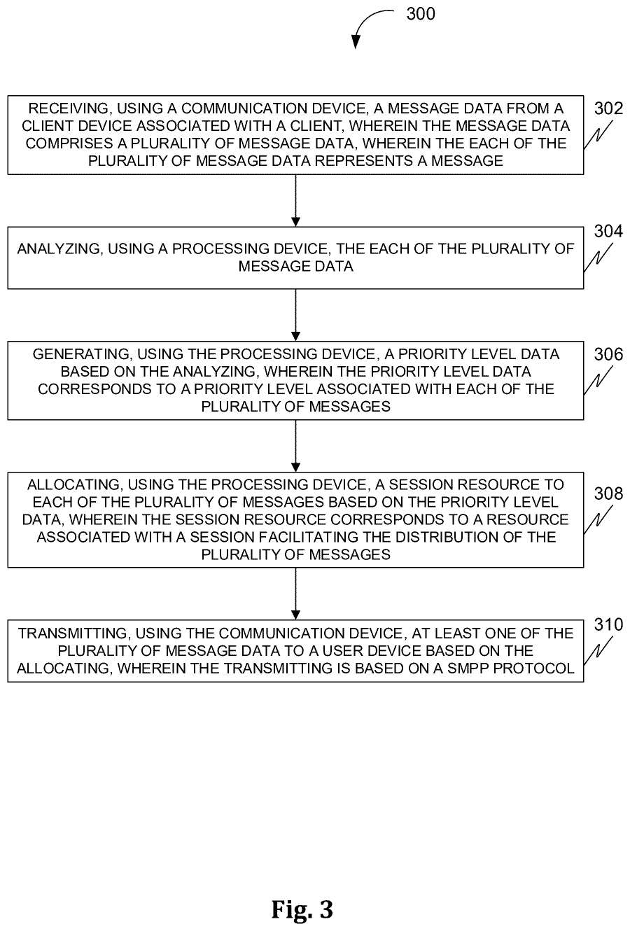

FIG. 3 illustrates a flowchart of a method 300 for facilitating management of distribution associated with a plurality of messages, in accordance with some embodiments.

Accordingly, the method 300 may include a step 302 of receiving, using a communication device 502, a message data from a client device associated with a client. Further, the message data includes two or more message data. Further, the each of the two or more message data represents a message. Further, the method 300 may include a step 304 of analyzing, using a processing device 504, the each of the two or more message data. Further, the method 300 may include a step 306 of generating, using the processing device 504, a priority level data based on the analyzing. Further, the priority level data corresponds to a priority level associated with each of the two or more messages. Further, the method 300 may include a step 308 of allocating, using the processing device 504, a session resource to each of the two or more messages based on the priority level data. Further, the session resource corresponds to a resource associated with a session facilitating the distribution of the two or more messages. Further, the method 300 may include a step 310 of transmitting, using the communication device 502, one or more of the two or more message data to a user device based on the allocating. Further, the transmitting may be based on a SMPP protocol.

In some embodiments, the priority level data includes two or more priority level data. Further, the two or more priority level data includes a first priority level data corresponding to a first priority level and a second priority level data corresponding to a second priority level. Further, the second priority level may be lower in priority in relation to the first priority level.

In some embodiments, the two or more message data includes one or more of a first priority message data corresponding to a first priority message and a second priority message data corresponding to a second priority message. Further, the first priority message data may be associated with the first priority level. Further, the second priority message data may be associated with the second priority level.

In some embodiments, the method 300 may further include generating, using the processing device 504, an order-of-delivery data based on the priority level data. Further, the order-of-delivery data corresponds to an order of delivery in relation to each of the two or more messages. Further, the transmitting may be further based on the order-of-delivery data.

In some embodiments, the order-of-delivery data includes a distribution queue data corresponding to a queue in relation to the distribution of the two or more messages.

In some embodiments, the queue includes two or more queues. Further, the two or more queues includes one or more of a first priority queue and a second priority queue. Further, the first priority queue may be associated with the first priority level. Further, the second priority queue may be associated with the second priority level.

In some embodiments, the distribution queue data includes a threshold value data corresponding to a threshold value associated with the each of the two or more queues. Further, the threshold value represents a predefined rate associated with the distribution of the two or more messages within the queue. Further, the allocating of the session resources may be further in relation to the priority level associated with each of the two or more queues.

In some embodiments, the message data includes a distribution rate data corresponding to a rate associated with the distribution of each of the two or more messages. Further, the distribution rate data includes two or more distribution rate data associated with the two or more queues.

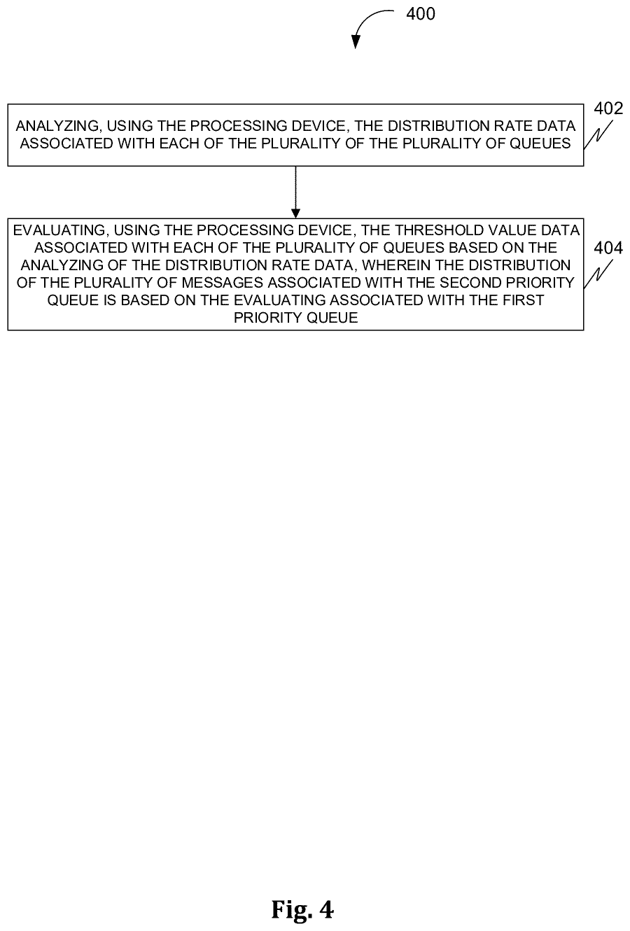

FIG. 4 illustrates a flowchart of a method 400 for facilitating management of distribution associated with a plurality of messages including evaluating, using the processing device 504, the threshold value data associated with each of the plurality of queues, in accordance with some embodiments.

Further, in some embodiments, the method 400 further may include a step 402 of analyzing, using the processing device 504, the distribution rate data associated with each of the plurality of the two or more queues. Further, in some embodiments, the method 400 further may include a step 404 of evaluating, using the processing device 504, the threshold value data associated with each of the two or more queues based on the analyzing of the distribution rate data. Further, the distribution of the two or more messages associated with the second priority queue may be based on the evaluating associated with the first priority queue.

In some embodiments, the method 300 may further include establishing, using the processing device 504, a SMPP connection in relation to a SMSC device associated with a SMSC. Further, the SMSC may be associated with a SMS provider. Further, the SMPP connection includes two or more SMPP connections. Further, the transmitting may be further based on each of the two or more SMPP connections. Further, the SMS provider includes two or more SMS providers. Further, the two or more SMPP connections in relation to the two or more SMS providers may be configured for facilitating a scalability associated with the distribution of the message.

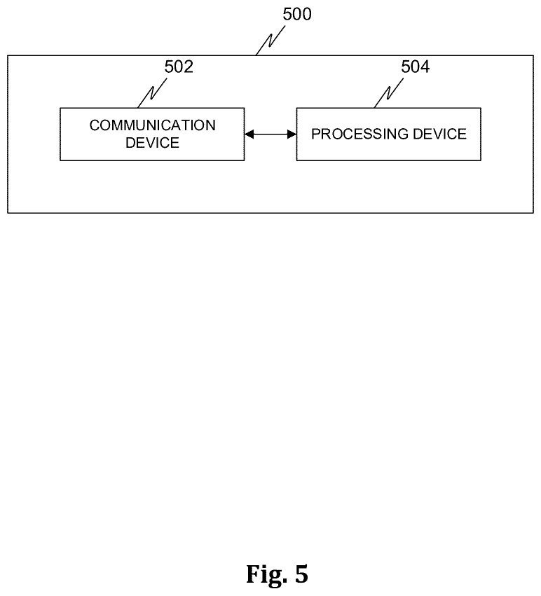

FIG. 5 illustrates a block diagram of a system 500 for facilitating management of distribution associated with a plurality of messages, in accordance with some embodiments.

Accordingly, the system 500 may include a communication device 502. Further, the communication device 502 may be configured for receiving a message data from a client device associated with a client. Further, the message data includes two or more message data. Further, the each of the two or more message data represents a message. Further, the communication device 502 may be configured for transmitting one or more of the two or more message data to a user device based on an allocating. Further, the transmitting may be based on a SMPP protocol. Further, the system 500 may include a processing device 504. Further, the processing device 504 may be configured for analyzing the each of the two or more message data. Further, the processing device 504 may be configured for generating a priority level data based on the analyzing. Further, the priority level data corresponds to a priority level associated with each of the two or more messages. Further, the processing device 504 may be configured for allocating a session resource to each of the two or more messages based on the priority level data. Further, the session resource corresponds to a resource associated with a session facilitating the distribution of the two or more messages.

In some embodiments, the priority level data includes two or more priority level data. Further, the two or more priority level data includes a first priority level data corresponding to a first priority level and a second priority level data corresponding to a second priority level. Further, the second priority level may be lower in priority in relation to the first priority level.

In some embodiments, the two or more message data includes one or more of a first priority message data corresponding to a first priority message and a second priority message data corresponding to a second priority message. Further, the first priority message data may be associated with the first priority level. Further, the second priority message data may be associated with the second priority level.

In some embodiments, the processing device 504 may be further configured for generating an order-of-delivery data based on the priority level data. Further, the order-of-delivery data corresponds to an order of delivery in relation to each of the two or more messages. Further, the transmitting may be further based on the order-of-delivery data.

In some embodiments, the order-of-delivery data includes a distribution queue data corresponding to a queue in relation to the distribution of the two or more messages.

In some embodiments, the queue includes two or more queues. Further, the two or more queues includes one or more of a first priority queue and a second priority queue. Further, the first priority queue may be associated with the first priority level. Further, the second priority queue may be associated with the second priority level.

In some embodiments, the distribution queue data includes a threshold value data corresponding to a threshold value associated with the each of the two or more queues. Further, the threshold value represents a predefined rate associated with the distribution of the two or more messages within the queue. Further, the allocating of the session resources may be further in relation to the priority level associated with each of the two or more queues.

In some embodiments, the message data includes a distribution rate data corresponding to a rate associated with the distribution of each of the two or more messages. Further, the distribution rate data includes two or more distribution rate data associated with the two or more queues.

Further, in some embodiments, the processing device 504 may be further configured for analyzing the distribution rate data associated with each of the plurality of the two or more queues. Further, the processing device 504 may be further configured for evaluating the threshold value data associated with each of the two or more queues based on the analyzing of the distribution rate data. Further, the distribution of the two or more messages associated with the second priority queue may be based on the evaluating associated with the first priority queue.

In some embodiments, the processing device 504 may be further configured for establishing a SMPP connection in relation to a SMSC device associated with a SMSC. Further, the SMSC may be associated with a SMS provider. Further, the SMPP connection includes two or more SMPP connections. Further, the transmitting may be further based on each of the two or more SMPP connections. Further, the SMS provider includes two or more SMS providers. Further, the two or more SMPP connections in relation to the two or more SMS providers may be configured for facilitating a scalability associated with the distribution of the message.

In some embodiments, the two or more message data further includes one or more of a high priority message data corresponding to a high priority message, a normal priority message data corresponding to a normal priority message, a low priority message data corresponding to a low priority message and a very-low priority message data corresponding to a very-low priority message.

In some embodiments, the queue further includes one or more of a high priority queue containing the high priority message, a normal priority queue containing the normal priority message, a low priority queue containing the low priority message and a very-low priority queue containing the very-low priority message.

In some embodiments, the scalability includes one or more of a capacitative scalability and a volumetric scalability. Further, the capacitative scalability corresponds to the scalability in relation to a capacity associated with the distribution of the message. Further, the volumetric scalability corresponds to the scalability in relation to a volume associated with the distribution.

In some embodiments, the transmitting may be further based on a transmission workload corresponding to a load associated with the transmitting. Further, the two or more SMPP connections may be further configured for facilitating a distribution of the workload.

In some embodiments, the session includes a SMPP session corresponding to an active state of communication established based on the SMPP connection.

In some embodiments, the SMPP session includes two or more SMPP sessions. Further, each of the two or more SMPP sessions may be associated with a maximum message rate corresponding to a maximum rate associated with the distribution of the two or more messages.

In some embodiments, the threshold value data may be further configured for facilitating management of a traffic associated with the distribution of the two or more messages.

In some embodiments, the allocating of the session resource may be further based on an allocation limit corresponding to a limit in relation to the session. Further, the allocation limit may be further configured for mitigating occurrence of a bottleneck in relation to the distribution of the two or more messages.

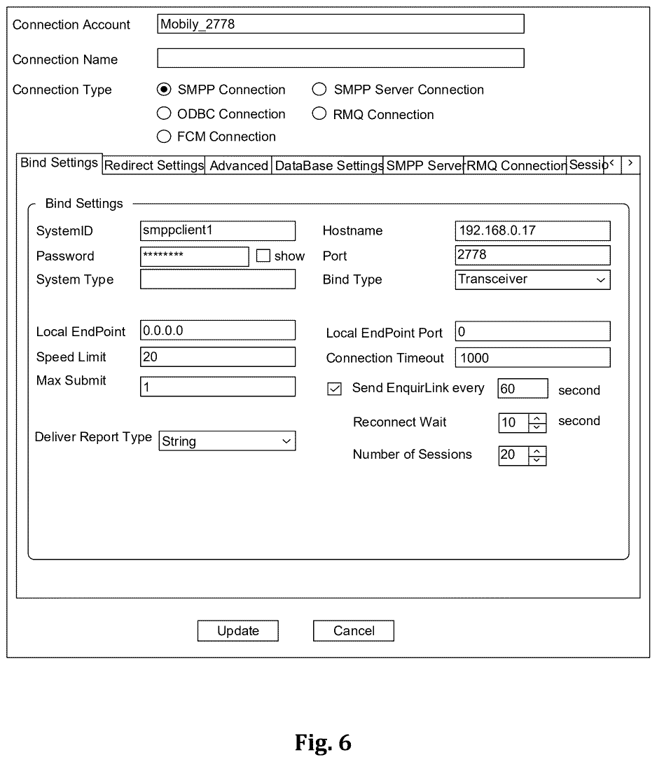

FIG. 6 illustrates a user interface associated with methods and systems for facilitating management of distribution associated with a plurality of messages, in accordance with some embodiments.

In some embodiments, the message data includes a client customization command data corresponding to a command in relation to a customization operation associated with the distribution. Further, the allocating may be further based on the client customization command data.

In some embodiments, the client customization command data includes a threshold customization data corresponding to the command in relation to the customization operation associated with the threshold value.

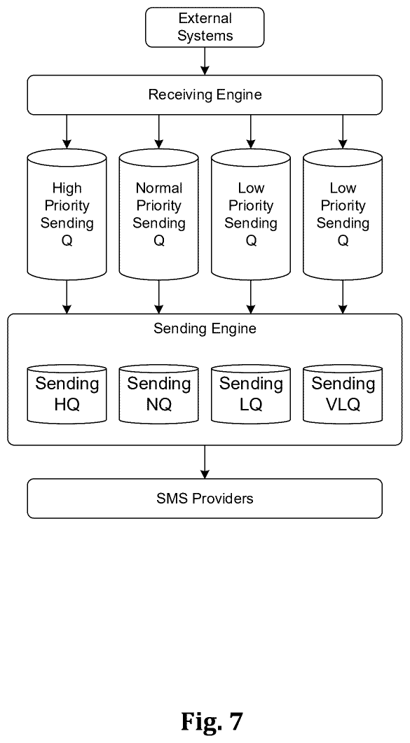

FIG. 7 illustrates a flowchart of priority distribution speed associated with methods and systems for facilitating management of distribution associated with a plurality of messages, in accordance with some embodiments.

In some embodiments, the method 300 may further include determining, using the processing device 504, an overall connection speed based on the allocating of the session resource. Further, the overall connection speed corresponds to a product of each of a count associated with the two or more SMPP sessions and the maximum message rate.

In some embodiments, the transmitting of the one or more of the two or more messages may be further based on the determining.

In some embodiments, each of the receiving and the allocating is based on a receiving engine.

In some embodiments, processing device may include a sending engine configured for facilitating each of the analyzing of the message data and management of distribution of the one or more messages based on the priority level.

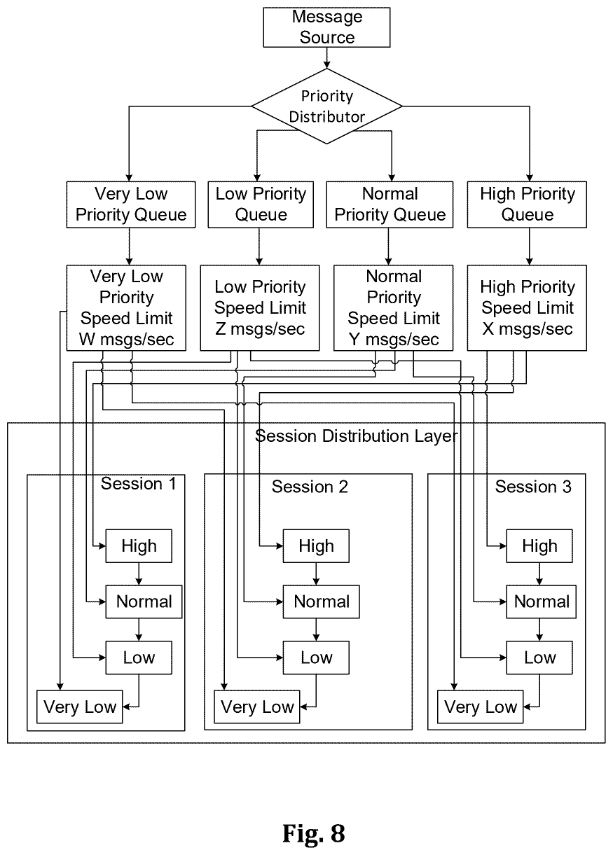

FIG. 8 illustrates a flowchart priority distribution speed associated with methods and systems for facilitating management of distribution associated with a plurality of messages, in accordance with some embodiments.

In some embodiments, the message data includes a message metadata corresponding to a metadata associated with the message.

In some embodiments, the message metadata includes a priority indication data corresponding to an indication in relation to the priority level associated with the message. Further, the allocating of the session resource may be further based on the priority indication data.

Although the invention has been explained in relation to its preferred embodiment, it is to be understood that many other possible modifications and variations can be made without departing from the spirit and scope of the invention as hereinafter claimed.

1. A method for facilitating management of distribution associated with a plurality of messages, wherein the method comprising:
receiving, using a communication device, a message data from a client device associated with a client, wherein the message data comprises a plurality of message data, wherein the each of the plurality of message data represents a message;
analyzing, using a processing device, the each of the plurality of message data;
generating, using the processing device, a priority level data based on the analyzing, wherein the priority level data corresponds to a priority level associated with each of the plurality of messages;
allocating, using the processing device, a session resource to each of the plurality of messages based on the priority level data, wherein the session resource corresponds to a resource associated with a session facilitating the distribution of the plurality of messages; and
transmitting, using the communication device, at least one of the plurality of message data to a user device based on the allocating, wherein the transmitting is based on a SMPP protocol.

2. The method of claim 1, wherein the priority level data comprises a plurality of priority level data, wherein the plurality of priority level data comprises a first priority level data corresponding to a first priority level and a second priority level data corresponding to a second priority level, wherein the second priority level is lower in priority in relation to the first priority level.

3. The method of claim 2, wherein the plurality of message data comprises at least one of a first priority message data corresponding to a first priority message and a second priority message data corresponding to a second priority message, wherein the first priority message data is associated with the first priority level, wherein the second priority message data is associated with the second priority level.

4. The method of claim 3 further comprising generating, using the processing device, an order-of-delivery data based on the priority level data, wherein the order-of-delivery data corresponds to an order of delivery in relation to each of the plurality of messages, wherein the transmitting is further based on the order-of-delivery data.

5. The method of claim 4, wherein the order-of-delivery data comprises a distribution queue data corresponding to a queue in relation to the distribution of the plurality of messages.

6. The method of claim 5, wherein the queue comprises a plurality of queues, wherein the plurality of queues comprises at least one of a first priority queue and a second priority queue, wherein the first priority queue is associated with the first priority level, wherein the second priority queue is associated with the second priority level.

7. The method of claim 6, wherein the distribution queue data comprises a threshold value data corresponding to a threshold value associated with the each of the plurality of queues, wherein the threshold value represents a predefined rate associated with the distribution of the plurality of messages within the queue, wherein the allocating of the session resources is further in relation to the priority level associated with each of the plurality of queues.

8. The method of claim 7, wherein the message data comprises a distribution rate data corresponding to a rate associated with the distribution of each of the plurality of messages, wherein the distribution rate data comprises a plurality of distribution rate data associated with the plurality of queues.

9. The method of claim 8 further comprising:
analyzing, using the processing device, the distribution rate data associated with each of the plurality of the plurality of queues; and
evaluating, using the processing device, the threshold value data associated with each of the plurality of queues based on the analyzing of the distribution rate data, wherein the distribution of the plurality of messages associated with the second priority queue is based on the evaluating associated with the first priority queue.

10. The method of claim 1 further comprising establishing, using the processing device, a SMPP connection in relation to a SMSC device associated with a SMSC, wherein the SMSC is associated with a SMS provider, wherein the SMPP connection comprises a plurality of SMPP connections, wherein the transmitting is further based on each of the plurality of SMPP connections, wherein the SMS provider comprises a plurality of SMS providers, wherein the plurality of SMPP connections in relation to the plurality of SMS providers are configured for facilitating a scalability associated with the distribution of the message.

11. A system for facilitating management of distribution associated with a plurality of messages, wherein the system comprising:
a communication device configured for:
receiving a message data from a client device associated with a client, wherein the message data comprises a plurality of message data, wherein the each of the plurality of message data represents a message; and
transmitting at least one of the plurality of message data to a user device based on an allocating, wherein the transmitting is based on a SMPP protocol; and
a processing device configured for:
analyzing the each of the plurality of message data;
generating a priority level data based on the analyzing, wherein the priority level data corresponds to a priority level associated with each of the plurality of messages; and
allocating a session resource to each of the plurality of messages based on the priority level data, wherein the session resource corresponds to a resource associated with a session facilitating the distribution of the plurality of message.

12. The system of claim 11, wherein the priority level data comprises a plurality of priority level data, wherein the plurality of priority level data comprises a first priority level data corresponding to a first priority level and a second priority level data corresponding to a second priority level, wherein the second priority level is lower in priority in relation to the first priority level.

13. The system of claim 12, wherein the plurality of message data comprises at least one of a first priority message data corresponding to a first priority message and a second priority message data corresponding to a second priority message, wherein the first priority message data is associated with the first priority level, wherein the second priority message data is associated with the second priority level.

14. The system of claim 13, wherein the processing device is further configured for generating an order-of-delivery data based on the priority level data, wherein the order-of-delivery data corresponds to an order of delivery in relation to each of the plurality of messages, wherein the transmitting is further based on the order-of-delivery data.

15. The system of claim 14, wherein the order-of-delivery data comprises a distribution queue data corresponding to a queue in relation to the distribution of the plurality of messages.

16. The system of claim 15, wherein the queue comprises a plurality of queues, wherein the plurality of queues comprises at least one of a first priority queue and a second priority queue, wherein the first priority queue is associated with the first priority level, wherein the second priority queue is associated with the second priority level.

17. The system of claim 16, wherein the distribution queue data comprises a threshold value data corresponding to a threshold value associated with the each of the plurality of queues, wherein the threshold value represents a predefined rate associated with the distribution of the plurality of messages within the queue, wherein the allocating of the session resources is further in relation to the priority level associated with each of the plurality of queues.

18. The system of claim 17, wherein the message data comprises a distribution rate data corresponding to a rate associated with the distribution of each of the plurality of messages, wherein the distribution rate data comprises a plurality of distribution rate data associated with the plurality of queues.

19. The system of claim 18, wherein the processing device is further configured for:
analyzing the distribution rate data associated with each of the plurality of the plurality of queues; and
evaluating the threshold value data associated with each of the plurality of queues based on the analyzing of the distribution rate data, wherein the distribution of the plurality of messages associated with the second priority queue is based on the evaluating associated with the first priority queue.

20. The system of claim 11, wherein the processing device is further configured for establishing a SMPP connection in relation to a SMSC device associated with a SMSC, wherein the SMSC is associated with a SMS provider, wherein the SMPP connection comprises a plurality of SMPP connections, wherein the transmitting is further based on each of the plurality of SMPP connections, wherein the SMS provider comprises a plurality of SMS providers, wherein the plurality of SMPP connections in relation to the plurality of SMS providers are configured for facilitating a scalability associated with the distribution of the message.
